(19) United States
(12) Patent Application Publication
(10) Pub. No.: US 2019/0009681 A1
(43) Pub. Date: Jan. 10, 2019

(54) METHOD AND APPARATUS FOR POSITIONING A MOTOR VEHICLE ABOVE A GROUND PLATE

(71) Applicant: Dr. Ing. h.c. F. Porsche Aktiengesellschaft, Stuttgart (DE)

(72) Inventors: Dirk Herke, Kirchheim unter Teck (DE); Anja Heinzelmann, Stuttgart (DE)

(21) Appl. No.: 15/964,090

(22) Filed: Apr. 27, 2018

(30) Foreign Application Priority Data
Jul. 10, 2017 (DE) 10 2017 115 327.6

(51) Int. Cl. B60L 11/18; G01V 3/10; G01S 15/93; G01S 7/00; H02J 50/90; H02J 7/02

(52) U.S. Cl. CPC B60L 11/1833; B60L 11/182; B60L 11/1825; B60L 11/1831; G01V 3/10; H02J 50/10; G01S 7/003; H02J 50/90; H02J 7/025; G01S 2015/932; G01S 15/931

(57) ABSTRACT

A method for positioning a motor vehicle above a ground plate includes determining, by ultrasonic sensors of the ground plate, data dependent on a location of the motor vehicle; transmitting the data from the ground plate to the motor vehicle by a radio connection; and carrying out positioning of the motor vehicle on the basis of the data until the location is above the ground plate.

### CROSS REFERENCE TO RELATED APPLICATIONS

This application claims benefit to German Patent Application No. DE 10 2017 115 327.6, filed Jul. 10, 2017, which is hereby incorporated by reference herein.

### FIELD

The present invention relates to a method for positioning a motor vehicle above a ground plate. The present invention also relates to a corresponding apparatus in the form of a ground plate.

### BACKGROUND

Inductive power transfer (IPT) between a first coil arranged in a ground unit and a second coil placed on the underbody of a vehicle is known. If the second coil—and therefore the vehicle itself—is positioned above the first coil, electrical power can be transferred to the vehicle in order to charge its battery. The practice of monitoring the air gap remaining between the ground unit and the vehicle when the vehicle is stationary during the power transfer operation by means of radar is also already known.

US20160025821A1 discloses guidance and alignment systems for wireless charging systems in order to support the alignment of the transmitter and receiver IPT couplers. These systems carry out the positioning and alignment in order to ensure adequate coupling between the transmitter and receiver IPT couplers. Exemplary systems provide a magnetic field sensor, a magnetic field generator and magnetic vectoring in order to determine a position of an electric vehicle or a wireless charging base. In such a magnetic guidance system, an alignment system comprising at least three coils (or similar circuits) on a magnetically permeable substrate receives a positioning magnetic field with modulated information signals and processes the received signal in order to generate an output signal for determining a position of the positioning magnetic field source relative to the magnetic field sensor position. The alignment system may also have a similar structure which generates the positioning magnetic field which may contain modulated information signals on the basis of input signals.

DE102015210314A1 discloses a method for determining the position of a motor vehicle relative to a primary coil of an inductive charging station by means of at least one distance sensor system of the motor vehicle. In this case, the distance sensor system has at least one transmitting part and one receiving part, the receiving part capturing at least the signals emitted by the transmitting part and capturing at least one distinguished point therefrom at a defined position with respect to the primary coil. A relative position of the motor vehicle with respect to the primary coil is then determined therefrom in an evaluation unit.

DE102013209235A1 relates to methods and apparatuses for position determination. Here, in the case of a relatively large distance between a vehicle and a charging station, use is made of a measuring method which determines a distance by means of absolute propagation time determination. A relative propagation time measurement is carried out between a plurality of received signals when the charging station and the vehicle are in a close range.

FR2936996B1 also describes a relevant method.

### SUMMARY

In an embodiment, the present invention provides a method for positioning a motor vehicle above a ground plate. The method includes determining, by ultrasonic sensors of the ground plate, data dependent on a location of the motor vehicle; transmitting the data from the ground plate to the motor vehicle by a radio connection; and carrying out positioning of the motor vehicle on the basis of the data until the location is above the ground plate.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an electric vehicle during use of a method according to an embodiment of the invention; and

FIG. 2 shows the possible use of different ultrasonic frequencies for improved position detection.

### DETAILED DESCRIPTION

One or more embodiments of the invention provide a method for positioning a motor vehicle above a ground plate and a ground plate.

In comparison with known methods which evaluate only the power transferred to the vehicle by the magnetic field of the ground plate, one or more embodiments of the present invention provide for improved and early positioning of the vehicle above the ground plate. In this case, embodiments of the invention are favorable in comparison with the conceivable fitting of additional field coils for positioning. A combination of additional field coils and an additional system, for example on the basis of ultrasound, is also conceivable.

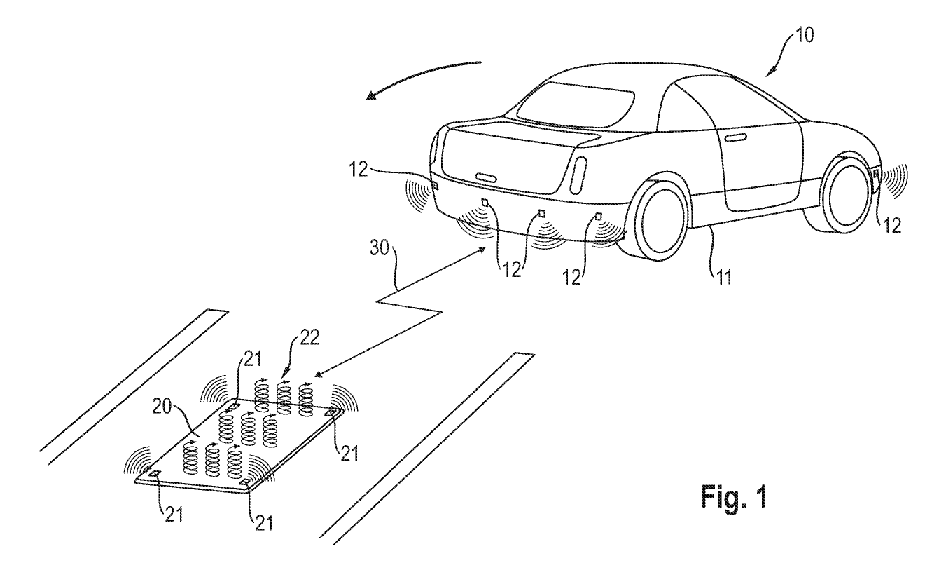

FIG. 1 illustrates the fundamental sequence of a method according to an embodiment of the invention for positioning a motor vehicle (10) above a ground plate (20). In the course of this method, ultrasonic sensors (21) of the ground plate (20) continuously determine data which depend on the location of the motor vehicle (10). The data determined in this manner are transmitted from the ground plate (20) to the motor vehicle (10) by means of WLAN, Bluetooth or another radio connection (30). The magnetic field strength, flux density or otherwise dimensioned intensity of the magnetic field induced in the motor vehicle (10) by the ground plate (20) or the power transferred in this manner may be additionally used to enrich said data. If the ground plate is below the vehicle, the vehicle ultrasonic sensors are blind. The positioning is carried out by means of an induced magnetic field in the vicinity while complying with the limit values or additional ultrasonic sensors in the VA.

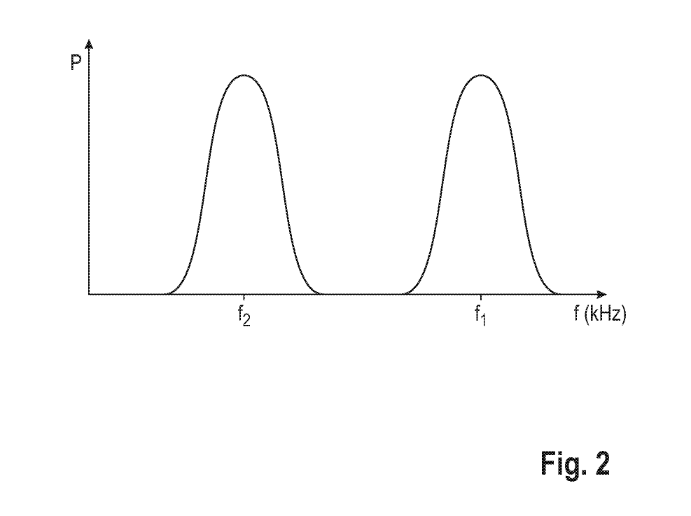

According to one option which is now explained on the basis of FIG. 2, the parking sensors (12) of the motor vehicle (10) can also be included in the position detection, for example by using different frequencies. For example, the ground plate (20) can regularly transmit and receive ultrasound at a frequency ƒ₁ of 44 kHz. If the motor vehicle (10) additionally transmits ultrasound at a frequency ƒ₂ of 33 kHz, for example, by means of its parking sensors (12), the ground plate (20) can change its measurement range from ƒₜ to ƒ₂ and can additionally evaluate this information.

Overall, there are three options. Option 1: positioning using a fixed frequency. Evaluation of the reflection. GA (Ground Assembly; ground plate) transmits; VA (vehicle plate, inductive) reflects. Option 2: like option 1 with the addition of the parking sensors in the automobile. Option 3: use of the vehicle parking sensors and calculation of the position using propagation time differences, for example. Or the vehicle ultrasonic sensors transmit in signals coded in a defined manner (for example using frequency or “transmission code similar to Morse code”) in order to only ever address one defined ultrasonic sensor of the ground plate in order to thus calculate the unknown variables of processing time, X position and Y position.

The vehicle is then the master of the positioning and the location position of the ground plate is then calculated in the vehicle.

The same could also be carried out in the reverse direction: the ultrasonic sensor of the ground plate transmits in signals coded in a defined manner. The ground plate can then calculate the location position. However, this information must then be transmitted in the direction of the vehicle.

On the basis of all these measurement data, the motor vehicle (10) is moved manually or automatically until its location is substantially above the ground plate (20). If the optimum position has been reached, the motor vehicle (10) can be coupled to the ground plate (20) in an inductive or resonantly inductive manner by means of the magnetic field in order to electrically charge its traction battery. The air gap remaining in this case between the underbody (11) of the motor vehicle (10) and the ground plate (20) is monitored during charging, for example by means of radar.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for positioning a motor vehicle above a ground plate, the method comprising:
determining, by ultrasonic sensors of the ground plate, data dependent on a location of the motor vehicle;
transmitting the data from the ground plate to the motor vehicle by a radio connection; and
carrying out positioning of the motor vehicle on the basis of the data until the location is above the ground plate.

2. The method as claimed in claim 1, further comprising:
determining, by parking sensors of the motor vehicle, further data dependent on the location,
wherein carrying out the positioning is also based on the further data.

3. The method as claimed in claim 1, wherein the radio connection comprises a wireless local area network or the radio connection comprises a wireless personal area network.

4. The method as claimed in claim 1, wherein the ground plate induces a magnetic field, and wherein carrying out the positioning is also based on an intensity of the magnetic field in the motor vehicle.

5. The method as claimed in claim 4, further comprising:
after carrying out the positioning, coupling the motor vehicle to the ground plate inductively by the magnetic field, and
after the coupling, electrically charging a traction battery of the motor vehicle.

6. The method as claimed in claim 5, wherein during charging, an air gap between an underbody of the motor vehicle and the ground plate is monitored.

7. A ground plate for carrying out a method for positioning a motor vehicle above the ground plate as claimed in claim 1, the ground plate comprising:
the ultrasonic sensors configured to determine data dependent on a location of the motor vehicle;
a transceiver for establishing the radio connection between the ground plate and the motor vehicle and for transmitting the data via the radio connection.
